(19) United States
(12) Patent Application Publication
(10) Pub. No.: US 2016/0063892 A1
(43) Pub. Date: Mar. 3, 2016

(54) STITCHING TEACH DEVICE AND APPLICATION

(71) Applicant: Gammill, Inc., West Plains, MO (US)

(72) Inventors: Daniel Lee Elliott, West Plains, MO (US); Joseph Wesley Bauman, Cabool, MO (US); Bettilou Kenney Langford, Stockton, MO (US)

(73) Assignee: Gammill, Inc., West Plains, MO (US)

(21) Appl. No.: 14/833,851

(22) Filed: Aug. 24, 2015

Related U.S. Application Data
(60) Provisional application No. 62/042,907, filed on Aug. 28, 2014.

(51) Int. Cl. G09B 19/20; G09B 5/02

(52) U.S. Cl. CPC G09B 19/20; G09B 5/02

(57) ABSTRACT

The present invention relates to a teach device for practicing methods of stitching quilts. The teach device includes a display device such as a computer tablet, handles for moving the teach device, and various electronic and computer components for tracking teach device movement and for storing quilting patterns within the memory of the teach device. The teach device may also be mounted within a docking device that performs some of the above functions and/or includes some of the above components. Moreover the teach device as taught may include a communications medium that allows it to be in communication with a computerized stitcher. When the teach device and computerized stitcher are in communication with one another, movements made by the teach device may be communicated to and reproduced by the computerized stitcher on a workpiece.

### CROSS-REFERENCE TO RELATED APPLICATIONS

This application claims the benefit of U.S. Provisional Application No. 62/042,907, filed Aug. 28, 2014, which is hereby incorporated by reference in its entirety.

### BACKGROUND OF INVENTION

The present invention relates to sewing. In particular, the invention relates to particular styles of sewing that incorporate decorative stitching such as quilting. A quilt is a type of blanket typically having three layers: a decorative top layer, a middle layer of insulating material, and a backing layer. “Quilting” refers to the technique of joining these layers by stitches or ties.

Traditional quilting was done by hand and was very labor intensive. The invention of the sewing machine changed that. Quilting evolved from production of functional blankets by specialized artisans into a popular hobby enjoyed by many.

Modern quilts are typically made using a long-armed sewing machine, or stitcher, attached to a frame. The frame supports and holds the workpiece in place while the sewing machine moves along the frame with respect to the workpiece.

Presently, two methods may be used to stitch quilts; the first is to manually guide fabric and the stitcher to achieve a desired pattern, and the second is to use a computer-guided stitcher to achieve a desired pattern. Computerized stitchers use a computer, motion controller, stepper/servo motors, belts, etc. to move the stitcher using computerized means. Computerized stitchers have become more popular in recent history because they increase speed and accuracy of quilting, and they may be used by persons having disabilities.

Despite the aforementioned advantages of computerized stitchers, manually quilting remains very popular among those who enjoy and feel satisfied when they perform the quilting themselves.

As previously described, the manual means of stitching using a sewing machine is a physical action. As with any physical action, an operator becomes faster and more accurate with experience. Thus many operators have a desire to gain experience in order to practice and hone their manual quilting skills. Practicing and honing a skill to the extent that it becomes nearly instinctual may be referred to as muscle memory.

Presently, the method to increase muscle memory development is to practice by using the user's sewing machine This requires the use of fabric, thread, etc. so the material costs alone can become substantial. As a result, the development of muscle memory not only takes considerable time, but it also requires spending significant amounts of money on materials.

Additionally, a user's sewing machine must be configured to allow the practice of developing muscle memory on the machine. If an in-process work piece is loaded onto the machine, it must be removed before practice may commence using a different work piece. This limits the time available for practice, and it greatly adds to the complexity in developing muscle memory.

Thus, it is desirable to provide an alternative solution to the aforementioned problems wherein a user may practice his or her quilting skills, but the user may do so without using and exhausting significant materials such as thread and quilting fabric. Moreover, the solution should not require significant adjusting and altering of the sewing machine such that the quilting process is interrupted and/or slowed. Yet, the solution should not compromise the ability of the user to develop muscle memory that may translate to better quilting skills. The solution may also allow persons having disabilities to get the “feel” of manual stitching but still be able to quilt given their disability.

### SUMMARY OF INVENTION

The present invention relates to a teach device and method used to teach muscle memory to a user of a quilting machine, more specifically a long-armed stitching machine, or stitcher. The teach device may include a docking device designed to simulate the look and feel of a stitcher. The docking device may include a cradle to mount a display device therein. The display device may be a tablet or other device capable of displaying an image thereon. The display device may be able to: display a digital pattern of the pattern to be practiced; display a cursor on the screen; create, edit, store, recall, and delete patterns; resize a pattern displayed thereon; receive data from the docking device as described herein below; and utilize the received data to move the cursor in coordination with the movement of the device on the table. In the preferred embodiment, the display device is a tablet, such as an Android tablet.

Two handles, one each on either side of the display device, may further be attached to side portions of the docking device. The handles may be used to slide the docking device on the surface of a table or other mounting surface. In one embodiment, the handles may further include buttons for user input.

Sensors, such as optical sensors, positioned and located on the rear of the docking device may detect and measure the motion of the docking device. A circuit board is further associated with the docking device that may collect data from the optical sensors, input buttons, or other components of the docking device. The circuit board may then send that data via a Bluetooth connection or other communication medium to the display device.

In an alternative embodiment, the display device described above may not have a docking device associated therewith. Instead, a user simply moves the display device on a table surface or other surface in order to simulate the stitching process using handles preferably mounted directly to the display device. In that embodiment, the display device may include an accelerometer, optical sensor, or other means for detecting and measuring movement of the display device. The display device may further include therein a software application. The application may be able to: display a digital representation of the pattern to be practiced on the display device's screen; display a cursor on the screen; create, edit, store, recall, and delete patterns; resize the pattern on the display; use the device sensors to detect and measure movement of the device on the table; and use the movement measurements to move either the cursor or the pattern on the screen in coordination with the movement of the device on the table.

In either of the above described embodiments, the teach device may perform an additional function. The display device or the docking device of the teach device may include a communications medium for communication with an associated computerized stitcher. In the preferred embodiment, both the teach device and an associated computerized stitcher are Wi-Fi enabled. Thus, the teach device may include a function wherein its movement may be sent via the communications medium to the computerized stitcher such that the computerized stitcher may reflect the movement of the teach device and replicate the pattern being performed on the teach device on the computerized stitcher and associated workpiece.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a front perspective view of a docking device and display device according to the teachings of the present invention.

FIG. 2 is a rear perspective view of the docking device and display device illustrated in FIG. 1.

### DETAILED DESCRIPTION OF THE INVENTION

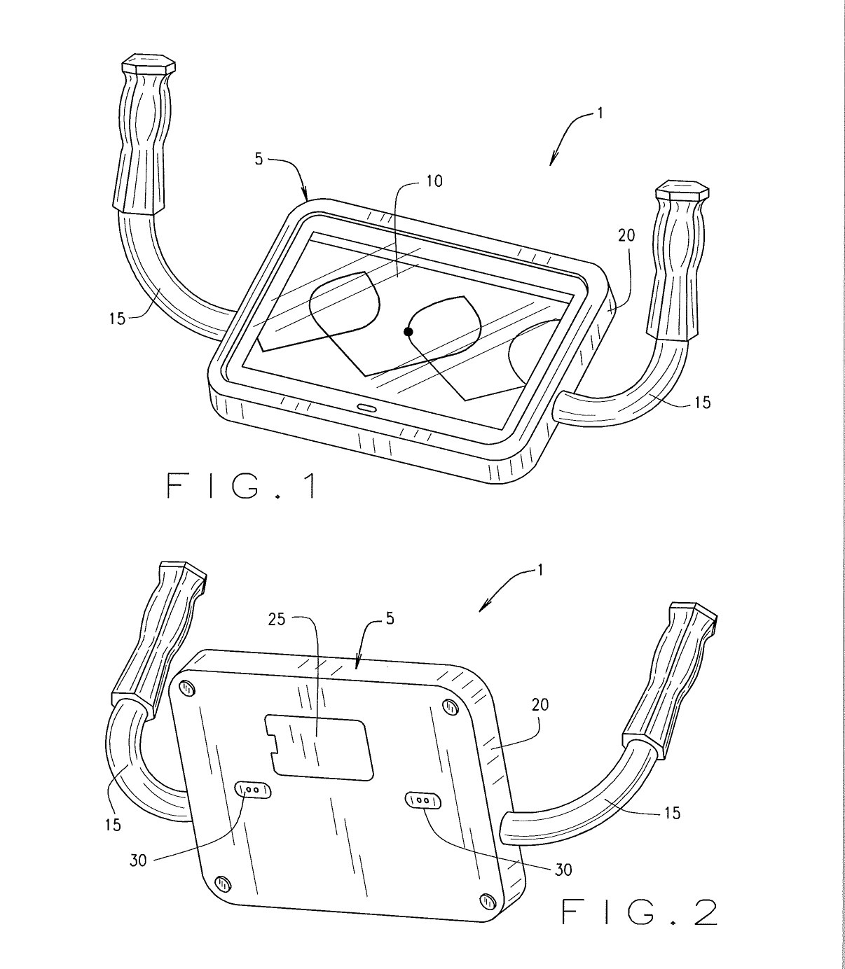

The present invention is directed generally toward a stitching teach device for developing muscle memory relating to the movements associated with operating a stitcher and further use for operating a stitcher associated therewith. FIG. 1 illustrates a front perspective view of stitching teach device 1, and FIG. 2 illustrates a rear perspective view of stitching teach device 1. Teach device 1 may include a cradle or docking device 5 surrounding and securing a display device 10. Display device 10 is preferably an Android tablet. Alternatively display device 10 may be an iPad, Galaxy, or other tablet known or foreseeable in the art. In FIG. 1 and FIG. 2, display device 10 is an Android tablet, and thus docking device 5 is sized and shaped for receiving and securing an Android tablet. Display device 10 may include a memory component as presently known in the art such that display device 10 may store various pantograph patterns therein. Pantograph patterns for being stored in display device 10 may be downloaded from the internet in manners known in the art. Further, display device 10 preferably includes a software application as commonly understood in the art for operating the invention described herein.

In alternative embodiments wherein display device 10 is a tablet or other device capable of executing the operations described herein, docking device 5 will be sized and shaped for receiving and securing the display device used in the alternative embodiment. In one non-limiting example, if the alternative teach device uses an iPad, the docking device will be sized and shaped to receive and secure an iPad.

Docking device 5 preferably includes one or more handles 15 extending from a side portion 20 of the docking device 5. The handles 15 are preferably substantially similar to handles that may be used on a stitcher known in the art. Docking device 5 preferably includes two handles 15 so as to simulate the feel of operating a stitcher known in the art. In alternative embodiments not herein illustrated, handles 15 may include user input buttons (not illustrated) for controlling various stitching settings. For example, the user input buttons may control stitch speed, stitch length, or other settings associated with operating a stitcher.

As illustrated in FIG. 2, the rear side of docking device 5 includes an access cover 25 for accessing various internal electronic and data components contained therein and discussed herein below. Access cover 25 may be selectively opened using a tab mechanism (not illustrated), as well understood in the art. As an alternative, access cover 25 may be selectively attached to docking device 5 using a screw mechanism.

Also illustrated in FIG. 2, the back portion of docking device 5 may further include one or more optical sensors 30. The optical sensors 30 may be photodiodes, photoelectric sensors, or other optical sensors as known or foreseeable to those skilled in the art. The illustrated embodiment includes two optical sensors 30, though other embodiments may include one optical sensor 30, or they may include more than two optical sensors 30.

Teach device 1 may be used in order to allow an operator thereof to practice the motion of stitching on a long armed stitcher. A user may hold handles 15 and move teach device 1 over a surface. When the teach device 1 is moved over a surface to simulate manual long-armed stitching, optical sensors 30 may track and record the movement of the teach device 1. The optical sensors 30 may be in electrical and/or data communication with a circuit board contained within docking device 5. Thus, as teach device 1 is moved over a surface, data captured by optical sensors 30 is preferably sent to the circuit board contained within docking device 5. The circuit board may then perform various calculations on the data to determine the movement of the teach device 1 relative to the surface upon which it is being moved. The data associated with the calculations may then be sent to display device 10 via a data connection therebetween. Preferably the data connection between the circuit board and display device 10 is a Bluetooth connection, though other communication means known or foreseeable in the art are envisioned.

Upon receiving the data from circuit board of docking device 5, display device 10 uses a plurality of functions that may be associated with the software application stored on display device 10. Display device 10 and its associated software application may display a digital representation of the pattern to be practiced, as well as a cursor on display device 10. The software application is preferably able to create, edit, store, recall, and delete patterns. It also is preferably able to resize a pattern displayed on display device 10.

Via its association with docking device 5, the software application associated with display device 10 further may use data received from the circuit board of docking device 5 in response to teach device 1 moving relative to an associated surface. The software application of display device 10 preferably uses received data associated with the movement of teach device 1 to move either the cursor or the pattern displayed on display device 10 in coordination with the movement of teach device 1.

In an alternative embodiment to the present invention (not illustrated), the invention does not include a docking device such as docking device 5. Instead, the invention includes display device 10 or a display device substantially similar to display device 10. The display device of the alternative embodiment is preferably an Android tablet, although other devices may be used, for example an iPad or Galaxy tablet. The display device of the alternative embodiment may further include an accelerometer or other sensor for detecting and/or measuring movement of the display device. A software application substantially similar to that described hereinabove may perform substantially the same operations as those described, the principal difference being that the movement of the display device would be measured by the accelerometer or other sensor contained within the display device rather than optical sensors 30.

In either of the above described embodiments, display device 10 or its substantially similar alternative may further be in data communication with a computerized stitcher as known in the art. In that embodiment as either teach device 1 or a display device (described in the alternative embodiment) is moved across a surface, the measurements of either device's movement relative to a surface may be further sent via a data connection, preferably Wi-Fi, to the computerized stitcher. Other data connections known or foreseeable in the art may also be utilized. When the data is sent, the computerized stitcher may stitch the movements associated with the device into fabric. This may effectively make the machine hand-guided, but without the operator strain and other complications that come from operating a large sewing machine

In the embodiment wherein the teach device 1 or a display device such as display device 10 may operate as a remote method for controlling a computerized stitcher, a small time delay may be implemented between the movements of one of the aforementioned devices and the stitching by the computerized stitcher. Thus, the operator may have the ability to stop and edit out mistakes or other unwanted stitches made digitally before they are physically reproduced by the computerized stitcher. Moreover, cameras may be placed on the head of the computerized stitcher which may be wirelessly connected to the display device via the Wi-Fi or other data connection described herein. The position and location of the needle and thread associated with the computerized stitcher may be displayed on the display device to more accurately position the remote stitching.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A stitching teach device for teaching muscle memory to a user of a quilting machine, the stitching teach device comprising:
a display device;
a docking device sized and configured for releasably engaging said display device, said docking device further comprising one or more optical sensors on a rear portion thereof for detecting the position of said docking device on a surface; and
a software application stored within an electronic memory of said display device, said software application performing the steps of:
determining the relative position and location of said docking device on a surface via said one or more optical sensors moving on said surface; and
recreating the relative position and location of said docking device on a screen of said display device relative to a virtual pattern.

2. The stitching teach device of claim 1, wherein the docking device includes one or more handles for guiding the stitching teach device.

3. The stitching teach device of claim 1, wherein the display device is in communication with a computerized stitcher.

4. The stitching teach device of claim 3, wherein the display device is in communication with the computerized stitcher via a wireless connection.

5. The stitching teach device of claim 1, wherein the display device includes an electronic memory operable for storing various pantograph patterns thereon.

6. The stitching teach device of claim 2, wherein the one or more handles include a plurality of user input buttons for controlling various stitching settings.

7. The stitching teach device of claim 1, wherein the display device is a tablet.

8. The stitching teach device of claim 1, wherein the display device includes an accelerometer for detecting movement of the display device.

9. The stitching teach device of claim 3, wherein the computerized stitcher recreates the movements of the teach device relative to a pantograph pattern on a quilt.

10. A stitching teach device for teaching muscle memory to a user of a quilting machine, the stitching teach device comprising:
a display device comprising an accelerometer;
a software application stored within an electronic memory of said display device, said software application performing the steps of:
determining the relative position and location of said display device on a surface via said accelerometer moving on said surface; and
recreating the relative position and location of said docking device on a screen of said display device relative to a virtual pattern.

11. The stitching teach device of claim 10, wherein the display device is in communication with a computerized stitcher.

12. The stitching teach device of claim 11, wherein the display device and the computerized stitcher are in communication via a wireless connection.

13. The stitching teach device of claim 10, wherein the stitching teach device further includes a docking device sized and configured for releasably engaging the display device

14. The stitching teach device of claim 13, wherein the docking device includes one or more handles for guiding the stitching teach device.

15. The stitching teach device of claim 14, wherein the docking device includes one or more optical sensors for detecting movement of the display device.

16. The stitching teach device of claim 15, wherein the one or more optical sensors are in communication with the software application of the display device.

17. The stitching teach device of claim 10, wherein the display device is a tablet.

18. The stitching teach device of claim 10, wherein the display device includes a memory operable for storing various pantograph patterns thereon.

19. The stitching teach device of claim 11, wherein the computerized stitcher recreates the movements of the display device relative to a pantograph pattern on a quilt.
